(19) United States
(12) Patent Application Publication
(10) Pub. No.: US 2020/0293864 A1
(43) Pub. Date: Sep. 17, 2020

(54) DATA-AWARE LAYER DECOMPOSITION FOR NEURAL NETWORK COMPRESSION

(71) Applicant: QUALCOMM Incorporated, San Diego, CA (US)

(72) Inventors: Markus NAGEL, Amsterdam (NL); Tijmen Pieter Frederik BLANKEVOORT, Amsterdam (NL)

(21) Appl. No.: 16/299,375

(22) Filed: Mar. 12, 2019

(51) Int. Cl. G06N 3/04; G06F 17/16

(52) U.S. Cl. CPC G06N 3/0481; G06F 17/16

(57) ABSTRACT

Certain aspects of the present disclosure are directed to methods and apparatus for operating an artificial neural network using data-aware layer decomposition. One exemplary method generally includes receiving a first input signal at a first layer of the artificial neural network; generating a first output signal of the first layer based, at least in part, on a weight matrix of the first layer and the first input signal; decomposing the weight matrix; generating an approximate output signal of the first layer based, at least in part, on the decomposed weight matrix and the first input signal; generating an updated decomposed weight matrix by minimizing a difference between the generated first output signal of the first layer and the approximate output signal of the first layer; and operating the first layer of the artificial neural network using the updated decomposed weight matrix.

### FIELD OF THE DISCLOSURE

The present disclosure generally relates to artificial neural networks and, more particularly, to data-aware layer decomposition for neural network compression.

### DESCRIPTION OF RELATED ART

An artificial neural network, which may be composed of an interconnected group of artificial neurons (e.g., neuron models), is a computational device or represents a method performed by a computational device. These neural networks may be used for various applications and/or devices, such as Internet Protocol (IP) cameras, Internet of Things (IoT) devices, autonomous vehicles, and/or service robots.

Individual nodes in the artificial neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation.” The weight values may initially be determined by an iterative flow of training data through the network (e.g., weight values are established during a training phase in which the network learns how to identify particular classes by their typical input data characteristics).

Different types of artificial neural networks exist, such as recurrent neural networks (RNNs), multilayer perceptron (MLP) neural networks, convolutional neural networks (CNNs), and the like. RNNs work on the principle of saving the output of a layer and feeding this output back to the input to help in predicting an outcome of the layer. In MLP neural networks, data may be fed into an input layer, and one or more hidden layers provide levels of abstraction to the data. Predictions may then be made on an output layer based on the abstracted data. MLPs may be particularly suitable for classification prediction problems where inputs are assigned a class or label. CNNs are a type of feed-forward artificial neural network. CNNs may include collections of artificial neurons that each have a receptive field (e.g., a spatially localized region of an input space) and that collectively tile an input space. CNNs have numerous applications; in particular, CNNs have broadly been used in the area of pattern recognition and classification.

In layered neural network architectures, the output of a first layer of artificial neurons becomes an input to a second layer of artificial neurons, the output of a second layer of artificial neurons becomes an input to a third layer of artificial neurons, and so on. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

### BRIEF SUMMARY

Certain aspects of the present disclosure are directed to a method for operating an artificial neural network. The method generally includes receiving a first input signal at a first layer of the artificial neural network; generating a first output signal of the first layer based, at least in part, on a weight matrix of the first layer and the first input signal; decomposing the weight matrix; generating an approximate output signal of the first layer based, at least in part, on the decomposed weight matrix and the first input signal; generating an updated decomposed weight matrix by minimizing a difference between the generated first output signal of the first layer and the approximate output signal of the first layer; receiving a second input signal at the first layer of the artificial neural network; and generating a second output signal of the first layer based, at least in part, on the second input signal and the updated decomposed weight matrix.

Certain aspects of the present disclosure are directed to an apparatus for operating an artificial neural network. The apparatus generally includes at least one processor configured to receive a first input signal at a first layer of the artificial neural network; generate a first output signal of the first layer based, at least in part, on a weight matrix of the first layer and the first input signal; decompose the weight matrix; generate an approximate output signal of the first layer based, at least in part, on the decomposed weight matrix and the first input signal; generate an updated decomposed weight matrix by minimizing a difference between the generated first output signal of the first layer and the approximate output signal of the first layer; receive a second input signal at the first layer of the artificial neural network; and generate a second output signal of the first layer based, at least in part, on the second input signal and the updated decomposed weight matrix. The apparatus may also include a memory coupled to the at least one processor.

Certain aspects of the present disclosure are directed to an apparatus for operating an artificial neural network comprising a plurality of neural processing units. The apparatus generally includes means for receiving a first input signal at a first layer of the artificial neural network; means for generating a first output signal of the first layer based, at least in part, on a weight matrix of the first layer and the first input signal; means for decomposing the weight matrix; means for generating an approximate output signal of the first layer based, at least in part, on the decomposed weight matrix and the first input signal; means for generating an updated decomposed weight matrix by minimizing the difference between the generated first output signal of the first layer and the approximate output signal of the first layer; means for receiving a second input signal at the first layer of the artificial neural network; and means for generating a second output signal of the first layer based, at least in part, on the second input signal and the updated decomposed weight matrix.

Certain aspects of the present disclosure are directed to a non-transitory computer-readable medium for operating an artificial neural network comprising a plurality of neural processing units. The non-transitory computer-readable medium generally includes instructions that, when executed by at least one processor, cause the at least one processor to receive a first input signal at a first layer of the artificial neural network; generate a first output signal of the first layer based, at least in part, on a weight matrix of the first layer and the first input signal; decompose the weight matrix; generate an approximate output signal of the first layer based, at least in part, on the decomposed weight matrix and the first input signal; generate an updated decomposed weight matrix by minimizing a difference between the generated first output signal of the first layer and the approximate output signal of the first layer; receive a second input signal at the first layer of the artificial neural network; and generate a second output signal of the first layer based, at least in part, on the second input signal and the updated decomposed weight matrix.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 illustrates an example implementation of a system-on-a-chip (SOC).

FIG. 2A illustrates an example of a fully connected neural network.

FIG. 2B illustrates an example of a locally connected neural network.

FIG. 2C illustrates an example of a convolutional neural network.

FIG. 2D illustrates a detailed example of a deep convolutional network (DCN) designed to recognize visual features from an image.

FIG. 3 is a block diagram illustrating a DCN.

FIG. 4 is a flow diagram of example operations for operating an artificial neural network using data-aware layer decomposition, according to aspects presented herein.

FIG. 5 is a block diagram illustrating an exemplary software architecture for modularizing artificial intelligence (AI) functions, according to aspects presented herein.

### DETAILED DESCRIPTION

Certain aspects of the present disclosure provide methods and apparatus for operating an artificial neural network using data-aware layer decomposition. Such methods may include techniques for improving the speed and accuracy of inferencing in an artificial neural network by considering the input signals and the activation functions of the artificial neural network in the decomposition solutions (e.g., gradient-based optimizations). In other words, the decomposition may be improved by directly optimizing the decomposition objective (e.g., ∥y−\tilde{y}∥², as explained below), which considers the input space of the activations, as opposed to optimizing the singular value decomposition of the weight matrix (e.g., ∥W−U·S·V^{T}∥²). Therefore, these techniques are generally referred to herein as “data-aware layer decomposition.”

With reference now to the Figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

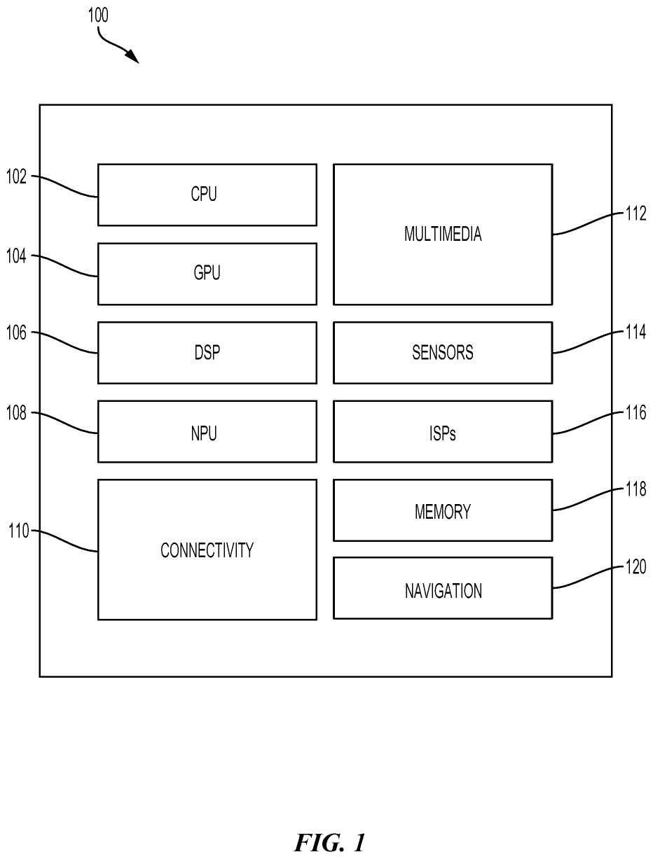

FIG. 1 illustrates an exemplary implementation of a system-on-a-chip (SOC) 100, which may include a central processing unit (CPU) 102 or a multi-core CPU configured to perform a data-aware layer decomposition for neural network compression, in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of input values (e.g., input vector components) may be compared with a threshold to predict to which class the input data belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

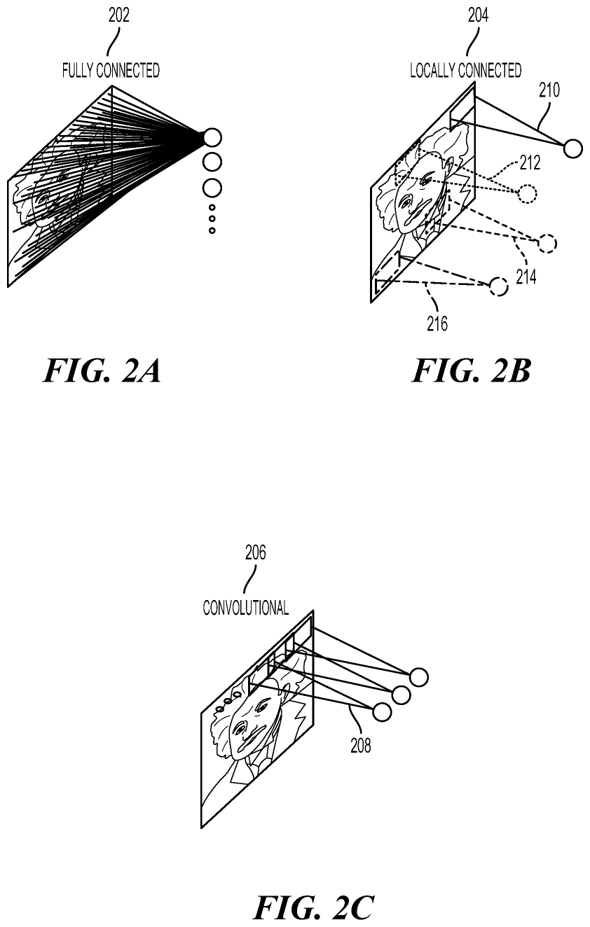

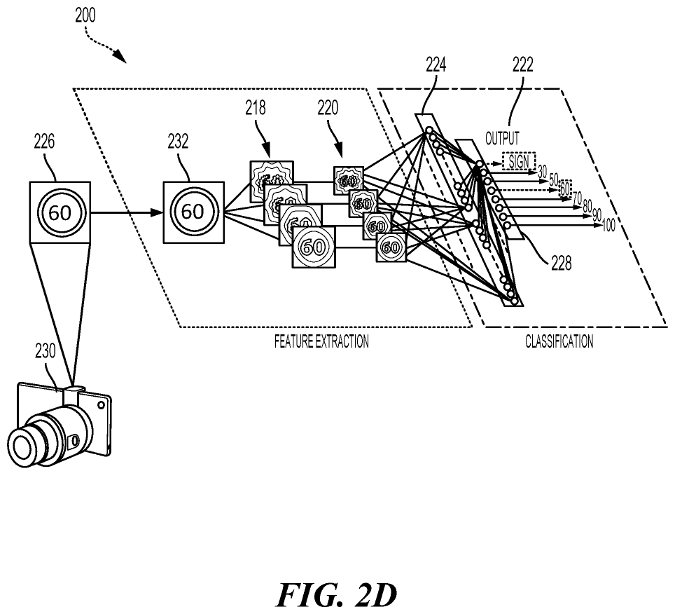

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

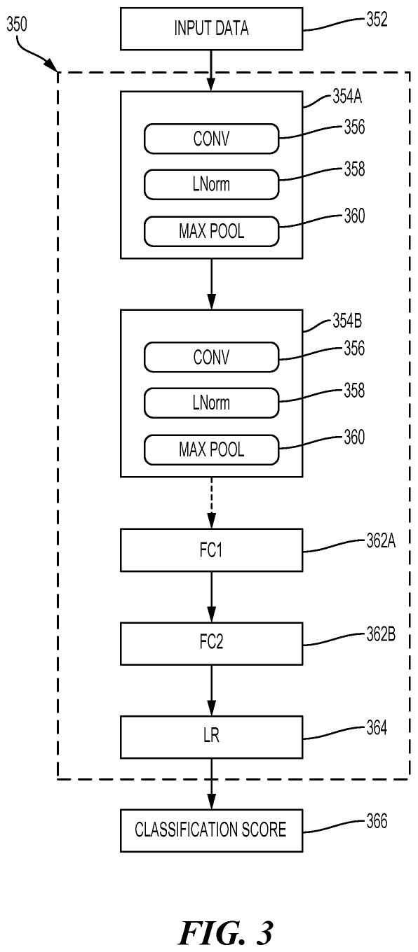

FIG. 3 is a block diagram illustrating an exemplary deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

Aspects of the present disclosure provide techniques for speeding up neural network inference with increased approximation accuracy and minimal loss in performance. Inference is the process whereby a trained artificial neural network makes inferences about new data the network is presented based on its training. That is, inferencing involves an artificial neural network taking batches of real-world data and returning a correct answer (e.g., a prediction that something is correct) as to what is observed in the data. In some cases, inferencing may consume an overly-long amount of time, especially in cases where the trained artificial neural network is applied to a specific use-case and the original training pipeline is not available to do end-to-end fine-tuning.

There may be several ways to achieve inference acceleration of artificial neural networks. For example, in some cases, inferencing may be sped up by quantization to low bit rate to allow more computations being performed at the same time. Additionally or alternatively, inferencing may be sped up by a structured reduction of the model size (e.g., compression) to lower the total amount of computations involved for inference. Aspects of the present disclosure provide techniques for speeding up inferencing that fall into this latter category.

Many solutions for speeding up inferencing rely on having an end-to-end fine-tuning pipeline available; however, as noted above, this may not be the case for many problems and may not be practical in real-life situations. For example, if a company wants to integrate compression tools in its software developer's kit (SDK) to allow application developers to deploy neural networks on integrated circuits (ICs) produced by the company, this SDK may not have access to the original training pipeline, for example, simply due to the exorbitant size of the original training pipeline. This may also be the case for developers that use pre-trained artificial neural networks from the Internet.

Thus, aspects of the present disclosure provide techniques that address this type of structured compression in an artificial neural network with no available fine-tuning training pipeline. According to aspects, the techniques presented herein may improve over existing compression methods, such as singular-value decomposition (SVD), for example, by considering input signals to the artificial neural network.

For example, neural network layer decomposition is traditionally performed by compressing a weight matrix. An output signal of a layer of the artificial neural network may be expressed as v=f(Wx), where x∈ [symbol] ⁿ is an n-dimensional input signal tensor (e.g., an input vector, and in some cases referred to as an “input activation”), W is an m×n weight matrix, f( ) is the activation function, and y∈ [symbol] ^{m} is an m-dimensional output signal. For example, as described above, a layer of the artificial neural network may receive an n-dimensional input signal (e.g., x). Each input signal may then be multiplied by a corresponding weight from an m×n a weight matrix (e.g., W). The resulting products may be summed, and an optional bias signal may be applied to the sum. Thereafter, an activation function ƒ may be applied to the (biased) sum to yield an output signal (e.g., y) of the layer. The activation function ƒ may be a linear or nonlinear function, such as a rectified linear unit (ReLU) or hyperbolic tangent function.

Since computing the output signal v directly is computationally intensive due to the size of W, SVD may be used to decompose W into three sub-matrices, by optimizing according to the expression ∥W−U·S·V^{T}∥², where ∥⋅∥2 is a least-squares normalization and the optimization entails solving for U, S, and V such that the distance between W and U·S·V^{T} is minimized. For example, the weight matrix W may be decomposed into a U sub-matrix, an S sub-matrix, and a V sub-matrix. The U sub-matrix may be a unitary m×m matrix (or sometimes m×n if n<m). Additionally, the S sub-matrix may be a diagonal m×n matrix, with singular values on the diagonal, and the V sub-matrix may be a unitary n×n matrix. In this manner, y=ƒ(U·S·V^{T}x), which can generally be more quickly calculated than y=f(Wx).

To further compress this neural network layer, an approximation for the sub-matrices may be used instead, where at least one of the approximated sub-matrices has a smaller matrix size than the original sub-matrix resulting from SYD. For instance, a low-rank approximation may be used to rank reduce W by keeping the k most significant singular values. In this case, new weight sub-matrices Û, Ŝ, and \hat{V} may be calculated. Rank-reduced weight sub-matrix Û∈ [symbol] ^{m×k}, where Û is a unitary m×k matrix, where m and k are positive natural numbers, and where k is less than m. Rank-reduced sub-matrix Ŝ∈ [symbol] ^{k×k}, where Ŝ is a diagonal k×k matrix. Rank-reduced sub-matrix \hat{V}∈ [symbol] ^{n×k}, where \hat{V} is a unitary n×k matrix, where n is a positive natural number, and where k is less than n. In some cases, another rank-reduced weight sub-matrix Û′ may be calculated according to Û′=Û·Ŝ, where Û′ is also an m×k matrix. In this manner, Û′ may be stored in memory instead of storing both Û and Ŝ. In addition to saving space, multiplying by Û′ instead of by Û·Ŝ reduces the number of computations for each output signal, thereby saving time and processing power.

Thereafter, once the weight matrix has been decomposed and rank-reduced into the smaller sub-matrices, an approximate output signal of the neural network layer, \tilde{y}, may be generated using the rank-reduced sub-matrices and the input signal, x. For example, \tilde{y} may be determined according to \tilde{y}=f(Û′(\hat{V}^{T}x)), where f is an activation function and where x is the input signal for the layer, as explained above. By approximating the output signal \tilde{y} in this manner, the computation may be reduced from m·n to (m+n)k, thereby reducing the delay in inferencing by reducing the total number of computations to make the overall calculation faster.

However, the input signals x∈ [symbol] ⁿ typically span a small subspace of [symbol] ⁿ, and thus, (optimally) approximating W may not provide suitable accuracy in approximating the output signals. In other words, while SVD significantly improves the speed of inferencing in artificial neural networks, especially with rank reduction, SVD (with or without rank reduction) does not take into account the input signals or the activation functions of the artificial neural network layer, thus making inferencing (e.g., approximating the output signals) less accurate when the artificial neural network is applied in a use-case specific manner without access to the original training data.

Accordingly, aspects of the present disclosure provide techniques for improving the speed and accuracy of inferencing in an artificial neural network by considering the input signals and the activation functions of the artificial neural network in the decomposition expressions (e.g., gradient-based optimizations). In other words, the decomposition may be improved by directly optimizing the decomposition objective (e.g., ∥y−\tilde{y}∥²), which considers the input space of the activations, as opposed to optimizing the singular value decomposition of the weight matrix (e.g., ∥W−U·S·V^{T}∥²). Therefore, these techniques are generally referred to herein as “data-aware layer decomposition.” Such data-aware layer decomposition may be expressed according to the following decomposition equation:

∥y−\tilde{y}∥²=∥f(Wx)−f(Û′(\hat{V}^{T}x)∥²=∥f(U·S·V^{T}x)−f(Û′(\hat{V}^{T}x)∥²

This equation may be used to determine values for Û′=Û·Ŝ and \hat{V} that minimize ∥y−\tilde{y}∥², for example, using any of various suitable gradient-based optimizers (e.g., stochastic gradient descent (SGD, also known as “incremental gradient descent”), adaptive moment estimation (Adam), etc.).

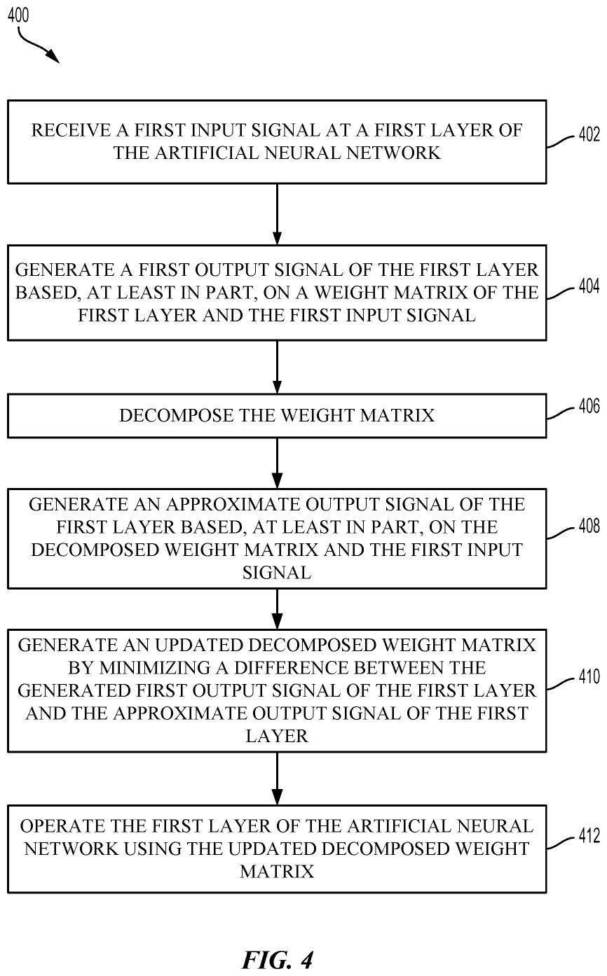

FIG. 4 is a flow diagram of example operations 400 for operating an artificial neural network, according to aspects presented herein. According to aspects, operations 400 may be performed, for example, by one or more processors, such as the neural processing unit 108.

Operations 400 begin at block 402 with the one or more processors receiving a first input signal (e.g., input tensor x) at a first layer of the artificial neural network. As used herein, the term “first layer” of the artificial neural network generally refers to any layer in the network, not necessarily the initial layer in the network, and is meant to distinguish between a second layer in the artificial neural network, which may be precede or follow the first layer and which may or may not be directly adjacent the first layer. According to certain aspects, the input signal may correspond to input data received at the artificial neural network. The input data may be any type of data that a neural network may be trained on, such as one or more sample images, one or more sample audio recordings, sample text, sample video, etc.

At block 404, the one or more processors generate a first output signal (e.g., output signal y=f(Wx)) of the first layer based, at least in part, on a weight matrix, W, of the first layer and the first input signal. For example, the weight matrix may be a full weight matrix W.

At block 406, the one or more processors decompose the weight matrix. For example, in some cases, the weight matrix, W, may be decomposed using singular value decomposition according to SVD(W)=U·S·V^{T}.

At block 408, the one or more processors generate an approximate output signal of the first layer (e.g., \tilde{y}) based, at least in part, on the decomposed weight matrix and the first input signal.

At block 410, the one or more processors generate an updated decomposed weight matrix by minimizing a difference between the generated first output signal of the first layer and the approximate output signal of the first layer. In some cases, minimizing the difference between the generated first output signal of the first layer and the approximate output signal of the first layer involves solving a least-squares problem (e.g., ∥y−\tilde{y}∥²=∥f(Wx)−f(Û′(\hat{V}^{T}x)∥²) between the generated output signal of the first layer and the approximated output signal of the first layer to generate an updated decomposed weight matrix, described in greater detail below.

At block 412, the one or more processors operate the first layer of the artificial neural network using the updated decomposed weight matrix (e.g., \tilde{y}=f(Û′(\hat{V}^{T}x))). For example, the processor(s) may operate the first layer using the updated decomposed weight matrix at block 412 by: (1) receiving a second input signal at the first layer of the artificial neural network; and (2) generating a second output signal of the first layer based, at least in part, on the second input signal and the updated decomposed weight matrix. In some cases, the additional second input and second output may be used to iteratively fine-tune the approximate output signal and, thereby, the updated decomposed weight matrix. By operating the neural network according to the (iteratively-fine-tuned) updated decomposed weight matrix, latency and accuracy for inferencing with the artificial neural network may be improved, as explained herein.

According to certain aspects, the operations 400 may also entail the one or more processors applying a low-rank approximation to the decomposed weight matrix from block 406. In this case, approximating the output signal of the first layer at block 408 may involve approximating the output signal of the first layer based, at least in part, on the low-rank-approximated decomposed weight matrix and the input signal. Applying the low-rank approximation may rank reduce the decomposed weight matrix by keeping the k most significant singular values of the decomposed weight matrix, where k is a positive natural number.

For example, decomposing the weight matrix at block 406 may involve singular value decomposition of the weight matrix, as explained above. In some cases, decomposing the weight matrix at block 406 may entail the processor(s) decomposing the weight matrix into a first weight sub-matrix, a second weight sub-matrix, and a third weight sub-matrix. According to certain aspects, the first weight sub-matrix may comprise Û∈ [symbol] ^{m×k}, where Û is a unitary m×k matrix, where m and k are positive natural numbers, and where k is less than m. Additionally, the second weight sub-matrix may comprise Ŝ∈ [symbol] ^{k×k}, where Ŝ is a diagonal k×k matrix. Further, the third weight sub-matrix may comprise \hat{V}∈ [symbol] ^{n×k}, where \hat{V} is a unitary n×k matrix, where n is a positive natural number, and where k is less than n. In some cases, the processor(s) may determine a fourth weight sub-matrix Û′ based on the first weight sub-matrix and the second weight sub-matrix. For example, the processor(s) may determine Û′ according to Û=Û·Ŝ, where is Û′ is also an m×k matrix. In this manner, Û′ may be stored in memory instead of storing both Û and Ŝ. In addition to saving space in memory, multiplying by Û′ instead of by Û·Ŝ reduces the number of computations for each output signal, thereby saving time and processing power.

Thereafter, after the weight matrix has been decomposed into the smaller sub-matrices, the processor(s) may then approximate the output signal of the first layer, \tilde{y}, using the decomposed weight matrix and the input signal, x, at block 408 as explained above. For example, for the first layer of the artificial neural network, the processor may determine according to \tilde{y}=f(Û′(\hat{V}^{T})), where f is an activation function, and where x is the input signal. According to certain aspects, the activation function may be a nonlinear function, such as a sigmoid function or a rectifier, such as implemented by a rectified linear unit (ReLU). According to certain aspects, by approximating the output signal \tilde{y} in this manner, computation may be reduced from m·n to (m+n)k operations, thereby reducing the delay in inferencing by reducing the total number of computations to make the overall calculation faster.

According to certain aspects, solving the least-squares problem between the generated output signal of the first layer and the approximated output signal of the first layer at block 410 is performed according to the following equation:

∥y−\tilde{y}∥²=∥f(Wx)−f(Û′(\hat{V}^{T}x)∥²

For certain aspects, f is nonlinear, as described above. For certain aspects, the updated decomposed weight matrix comprises an updated first weight sub-matrix (Û), an updated second weight sub-matrix (Ŝ), and an updated third weight sub-matrix (\hat{V}), where, as noted above, Û′=Û·Ŝ. In some cases, the processor(s) may solve the least-square problem by selecting values for each of the updated first, second, and third weight sub-matrices that minimize the difference between the generated output signal of the first layer and the approximated output signal of the first layer.

The least-squares problem may be solved at block 410 using any of various suitable gradient-based optimizers (e.g., SGD, Adam, etc.). In other words, the processor(s) may implement a gradient-based optimizer. Solving the least-squares problem may be an iterative process, using multiple input signals to fine-tune the weight sub-matrices. In some cases, the approximated output signal may be initialized for this iterative process using a singular-value decomposition (e.g., SVD of the weight matrix), but may also begin with any other type of decomposition or with randomly initialized decomposition matrices.

In this manner, to resolve the (approximate) input/output space of the first layer of the artificial neural network, the processor(s) need not know any information from the original training setup (e.g., how the network was trained to generate the weight matrix). For the techniques presented herein, it may be sufficient to know the type of input to the neural network (e.g. natural images, audio recordings, etc.). The processor(s) may then use samples from the same domain (e.g., as the type of input signal) and perform inferencing on the samples (e.g., the samples need not be from the original training dataset). For example, the processor(s) may perform inferencing on several inputs, x, and layers of the artificial neural network, collecting the input and output signals (e.g., x and y, respectively) of each layer, which may then be used to solve the least squares problem of the data-aware layer decomposition for the various layers of the artificial neural network. According to certain aspects, knowing the input data allows an operator of the neural network to process similar data through the neural network to obtain samples for y and x, which then allows the neural network to solve the least squares problem described above using SGD, Adam, etc. In other words, knowing the input data allows an operator to retrain the neural network for a specific use-case without needing the original training data of the neural network (which is usually not accessible).

According to certain aspects, the operations 400 may further include the processor(s) storing the updated decomposed weight matrix in memory (e.g., memory block 118) for the artificial neural network.

According to certain aspects, after determining the approximated output signal for the first layer (e.g., at block 408) or after operating the first layer of the artificial neural network using the updated decomposed weight matrix (e.g., at block 412), the approximated output signal of the first layer may be used as an input to a second layer of the neural network to determine an approximated output signal of the second layer. In this case, the second layer may be adjacent and subsequent to the first layer.

The techniques presented herein provide several advantages over existing layer decomposition methods. For example, as noted above, the techniques presented herein consider the input space of the activations x∈ [symbol] ⁿ and the activation function ƒ (including any the nonlinearity thereof) when optimizing (or otherwise solving for) the layers of the neural network. For example, directly optimizing (or solving) for the layer's output significantly improves results compared to decomposing the weight matrix. Additionally, the optimization, performed according to the techniques presented herein, is performed iteratively, thus considering any number of activations, leading to an increase in accuracy of the output signals. Further, the techniques presented herein are fast, do not require an end-to-end fine-tuning pipeline, and can be applied to any type of neural network (e.g., RNN or CNN).

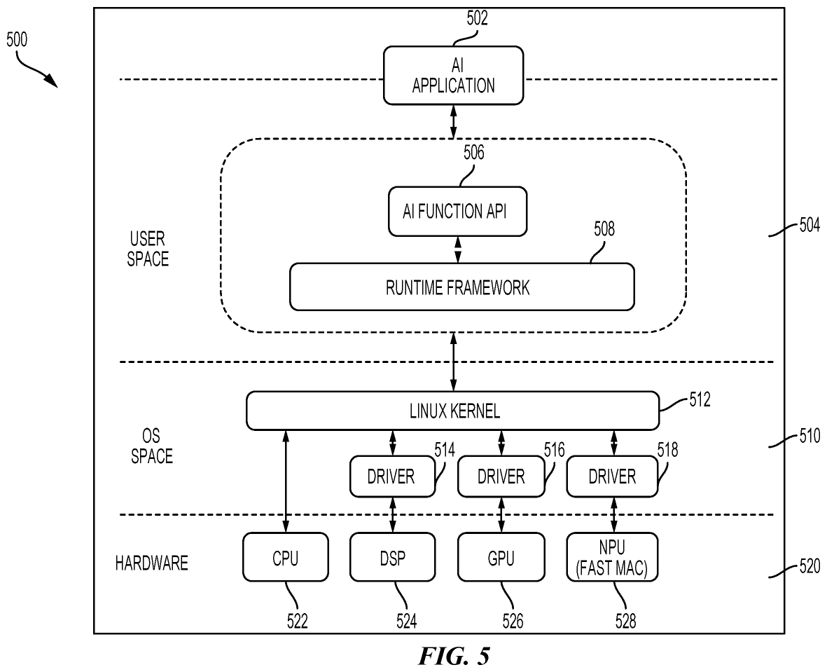

FIG. 5 is a block diagram illustrating an exemplary software architecture 500 that may modularize artificial intelligence (AI) functions. Using the architecture, applications may be designed that may cause various processing blocks of an SOC 520 (for example a CPU 522, a DSP 524, a GPU 526, and/or an NPU 528) to support data-aware layer decomposition for neural network compression for run-time operation of an AI application 502, according to aspects of the present disclosure.

The AI application 502 may be configured to call functions defined in a user space 504 that may, for example, provide for the detection and recognition of a scene indicative of the location in which the device currently operates. The AI application 502 may, for example, configure a microphone and a camera differently depending on whether the recognized scene is an office, a lecture hall, a restaurant, or an outdoor setting such as a lake. The AI application 502 may make a request to compiled program code associated with a library defined in an AI function application programming interface (API) 506. This request may ultimately rely on the output of a deep neural network configured to provide an inference response based on video and positioning data, for example.

A run-time engine 508, which may be compiled code of a runtime framework, may be further accessible to the AI application 502. The AI application 502 may cause the run-time engine, for example, to request an inference at a particular time interval or triggered by an event detected by the user interface of the application. When caused to provide an inference response, the run-time engine may in turn send a signal to an operating system in an operating system (OS) space 510, such as a Linux Kernel 512, running on the SOC 520. The operating system, in turn, may cause a data-aware layer decomposition function to be performed on the CPU 522, the DSP 524, the GPU 526, the NPU 528, or some combination thereof. The CPU 522 may be accessed directly by the operating system, and other processing blocks may be accessed through a driver, such as a driver 514, 516, or 518 for, respectively, the DSP 524, the GPU 526, or the NPU 528. In the exemplary example, the deep neural network may be configured to run on a combination of processing blocks, such as the CPU 522, the DSP 524, and the GPU 526, or may be run on the NPU 528.

As noted above, aspects presented herein provide techniques for accelerating and improving the accuracy of inferencing in an artificial neural network. For example, improving the accuracy and speeding up neural network inferencing may involve generating an output signal of a first layer, approximating the output signal, and updating a decomposed weight matrix, used to generate the approximated output signal, based on a solution to a least-squares problem between the generated output signal and the approximated output signal.

The various illustrative circuits described in connection with aspects described herein may be implemented in or with an integrated circuit (IC), such as a processor, a digital signal processor (DSP), an application-specific integrated circuit (ASIC), a field-programmable gate array (FPGA), or other programmable logic device. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is also noted that the operational steps described in any of the exemplary aspects herein are described to provide examples. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The present disclosure is provided to enable any person skilled in the art to make or use aspects of the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

1. A method for operating an artificial neural network, comprising:
receiving a first input signal at a first layer of the artificial neural network;
generating a first output signal of the first layer based, at least in part, on a weight matrix of the first layer and the first input signal;
decomposing the weight matrix;
generating an approximate output signal of the first layer based, at least in part, on the decomposed weight matrix and the first input signal;
generating an updated decomposed weight matrix by minimizing a difference between the generated first output signal of the first layer and the approximate output signal of the first layer;
receiving a second input signal at the first layer of the artificial neural network; and
generating a second output signal of the first layer based, at least in part, on the second input signal and the updated decomposed weight matrix.

2. The method of claim 1, further comprising applying a low-rank approximation to the decomposed weight matrix, wherein generating the approximate output signal of the first layer comprises generating the approximate output signal of the first layer based, at least in part, on the low-rank-approximated decomposed weight matrix and the first input signal.

3. The method of claim 2, wherein applying the low-rank approximation to the decomposed weight matrix comprises keeping the k most significant singular values of the decomposed weight matrix, where k is a positive natural number.

4. The method of claim 1, wherein decomposing the weight matrix comprises decomposing the weight matrix into at least a first weight sub-matrix, a second weight sub-matrix, and a third weight sub-matrix.

5. The method of claim 4, wherein:
the first weight sub-matrix comprises Û∈ [symbol] ^{m×k}, where Û is a unitary m×k matrix, where in and k are positive natural numbers, and where k is less than m;
the second weight sub-matrix comprises Ŝ∈ [symbol] ^{k×k}, where Ŝ is a diagonal k×k matrix; and
the third weight sub-matrix comprises \hat{V}∈ [symbol] ^{n×k}, where \hat{V} is a unitary n×k matrix, where n is a positive natural number, and where k is less than n.

6. The method of claim 5, further comprising:
determining a fourth weight sub-matrix (Û′) based, at least in part, on the first weight sub-matrix and the second weight sub-matrix, wherein Û′=Û·Ŝ.

7. The method of claim 6, wherein generating the approximate output signal of the first layer comprises determining \tilde{y}, where \tilde{y}=f(Û′(\hat{V}^{T}x)), where f is an activation function, and where x is the first input signal.

8. The method of claim 7, wherein minimizing the difference between the generated first output signal of the first layer and the approximate output signal of the first layer comprises solving a least-squares problem between the generated first output signal of the first layer and the approximate output signal of the first layer.

9. The method of claim 8, wherein solving the least-squares problem between the generated first output signal of the first layer and the approximate output signal of the first layer is performed according to:
∥y−\tilde{y}∥²=∥f(Wx)−f(Û′(\hat{V}^{T}x)∥²
where y=f(Wx) and W is the weight matrix.

10. The method of claim 9, wherein f is nonlinear.

11. The method of claim 9, wherein the updated decomposed weight matrix comprises an updated first weight sub-matrix (Û), an updated second weight sub-matrix (Ŝ) and an updated third weight sub-matrix (\hat{V}).

12. The method of claim 11, wherein solving the least-squares problem comprises selecting values for each of the updated first, second, and third weight sub-matrices that minimize the difference between the generated first output signal of the first layer and the approximate output signal of the first layer.

13. The method of claim 8, wherein solving the least-squares problem is performed by a gradient-based optimizer.

14. The method of claim 1, wherein the first input signal received at the first layer is an output signal of a second layer of the artificial neural network.

15. The method of claim 1, wherein:
the first input signal corresponds to input data received at the artificial neural network; and
the input data comprises at least one of sample images, sample audio, or sample text.

16. The method of claim 1, further comprising storing the updated decomposed weight matrix in memory of the artificial neural network.

17. An apparatus for operating an artificial neural network, comprising:
at least one processor configured to:
receive a first input signal at a first layer of the artificial neural network;
generate a first output signal of the first layer based, at least in part, on a weight matrix of the first layer and the first input signal;
decompose the weight matrix;
generate an approximate output signal of the first layer based, at least in part, on the decomposed weight matrix and the first input signal;
generate an updated decomposed weight matrix by minimizing a difference between the generated first output signal of the first layer and the approximate output signal of the first layer;
receive a second input signal at the first layer of the artificial neural network; and
generate a second output signal of the first layer based, at least in part, on the second input signal and the updated decomposed weight matrix; and
a memory coupled to the at least one processor.

18. The apparatus of claim 17, wherein the at least one processor is further configured to apply a low-rank approximation to the decomposed weight matrix and wherein generating the approximate output signal of the first layer comprises generating the approximate output signal of the first layer based, at least in part, on the low-rank-approximated decomposed weight matrix and the first input signal.

19. The apparatus of claim 18, wherein applying the low-rank approximation to the decomposed weight matrix comprises keeping the k most significant singular values of the decomposed weight matrix, where k is a positive natural number.

20. The apparatus of claim 17, wherein the at least one processor is configured to decompose the weight matrix by decomposing the weight matrix into at least a first weight sub-matrix, a second weight sub-matrix, and a third weight sub-matrix.

21. The apparatus of claim 20, wherein:
the first weight sub-matrix comprises Û∈ [symbol] ^{m×k}, where Û is a unitary m×k matrix, where in and k are positive natural numbers, and where k is less than m;
the second weight sub-matrix comprises Ŝ∈ [symbol] ^{k×k}, where Ŝ is a diagonal k×k matrix; and
the third weight sub-matrix comprises \hat{V}∈ [symbol] ^{n×k}, where \hat{V} is a unitary n×k matrix, where n is a positive natural number, and where k is less than n.

22. The apparatus of claim 21, wherein the at least one processor is further configured to:
determine a fourth weight sub-matrix (Û′) based, at least in part, on the first weight sub-matrix and the second weight sub-matrix, wherein Û′=Û·Ŝ.

23. The apparatus of claim 22, wherein the at least one processor is configured to generate the approximate output signal of the first layer by determining \tilde{y}, where \tilde{y}=f(Û′(\hat{V}^{T}x)) where f is an activation function, and where x is the first input signal.

24. The apparatus of claim 23, wherein the at least one processor is configured to minimize the difference between the generated first output signal of the first layer and the approximate output signal of the first layer by solving a least-squares problem between the generated first output signal of the first layer and the approximate output signal of the first layer.

25. The apparatus of claim 24, wherein the at least one processor is configured to solve the least-squares problem between the generated first output signal of the first layer and the approximate output signal of the first layer according to:
∥y−\tilde{y}∥²=∥f(Wx)−f(Û′(\hat{V}^{T}x)∥²
where y=f(Wx) and W is the weight matrix.

26. The apparatus of claim 25, wherein f is nonlinear.

27. The apparatus of claim 25, wherein the updated decomposed weight matrix comprises an updated first weight sub-matrix (Û), an updated second weight sub-matrix (Ŝ), and an updated third weight sub-matrix (\hat{V}).

28. The apparatus of claim 27, wherein the at least one processor is configured to solve the least-squares problem by selecting values for each of the updated first, second, and third weight sub-matrices that minimize the difference between the generated first output signal of the first layer and the approximate output signal of the first layer.

29. An apparatus for operating an artificial neural network, comprising:
means for receiving a first input signal at a first layer of the artificial neural network;
means for generating a first output signal of the first layer based, at least in part, on a weight matrix of the first layer and the first input signal;
means for decomposing the weight matrix;
means for generating an approximate output signal of the first layer based, at least in part, on the decomposed weight matrix and the first input signal;
means for generating an updated decomposed weight matrix by minimizing a difference between the generated first output signal of the first layer and the approximate output signal of the first layer;
means for receiving a second input signal at the first layer of the artificial neural network; and
means for generating a second output signal of the first layer based, at least in part, on the second input signal and the updated decomposed weight matrix.

30. A non-transitory computer-readable medium for operating an artificial neural network, comprising:
instructions that, when executed by at least one processor, cause the at least one processor to:
receive a first input signal at a first layer of the artificial neural network;
generate a first output signal of the first layer based, at least in part, on a weight matrix of the first layer and the first input signal;
decompose the weight matrix;
generate an approximate output signal of the first layer based, at least in part, on the decomposed weight matrix and the first input signal;
generate an updated decomposed weight matrix by minimizing a difference between the generated first output signal of the first layer and the approximate output signal of the first layer;
receive a second input signal at the first layer of the artificial neural network; and
generate a second output signal of the first layer based, at least in part, on the second input signal and the updated decomposed weight matrix.
